(19) United States
(12) Patent Application Publication
(10) Pub. No.: US 2009/0252962 A1
(43) Pub. Date: Oct. 8, 2009

(54) USE OF FORMALDEHYDE-FREE AQUEOUS BINDERS FOR SUBSTRATES

(75) Inventors: Kathrin Michl, Ludwigshafen (DE); Matthias Gerst, Neustadt (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Basf Aktiengesellschaft

(21) Appl. No.: 11/721,922

(22) PCT Filed: Dec. 14, 2005
(86) PCT No.: PCT/EP2005/013404

§ 371 Date: Jun. 15, 2007

(30) Foreign Application Priority Data
Dec. 16, 2004 (DE) 102004061144.0

(51) Int. Cl. B32B 21/02; C08L 33/02; B05D 3/02; B32B 17/10; B32B 17/04; B32B 21/08; B32B 9/04

(52) U.S. Cl. 428/375; 525/192; 427/389.8; 428/441; 428/442; 428/407; 428/455; 428/514

(57) ABSTRACT

The present invention relates to the use of formaldehyde-free aqueous binders having a broad molecular weight distribution for substrates, said binders comprising
(A) from 0 to 100% by weight of an ethylenically unsaturated acid anhydride or ethylenically unsaturated dicarboxylic acid whose carboxylic acid groups can form an anhydride group, or mixtures thereof,
(B) from 100 to 0% by weight of an ethylenically unsaturated compound,
(C) at least one polyfunctional crosslinker or mixtures thereof, and
(D) from 1-80% by weight of an aqueous polymer dispersion, the polymers of A) and B) obtained by free-radical addition polymerization, when classified in a coordinate system by way of their average molecular weight Mw and their polydispersity, being situated in the area above a straight line which is defined by the linear equation y=1.25x+20 000 and has been shifted in y direction parallelwise by at least +3 000, the x axis denoting the weight-average molecular weight and the y axis the polydispersity times 10 000.

The invention further relates to the binders themselves and also to their use for, for example, moldings, mats or boards, especially for fibrous and particulate substrates such as fiber webs, glass fibers, rockwool, reclaimed cotton, natural fibers or synthetic fibers.

The present invention relates to the use of formaldehyde-free aqueous binders having a broad molecular weight distribution for substrates, said binders comprising
(A) from 0 to 100% by weight of an ethylenically unsaturated acid anhydride or ethylenically unsaturated dicarboxylic acid whose carboxylic acid groups can form an anhydride group, or mixtures thereof,
(B) from 100 to 0% by weight of an ethylenically unsaturated compound,
(C) at least one polyfunctional crosslinker or mixtures thereof,
(D) from 1-80% by weight of an aqueous polymer dispersion,
   the polymers of A) and B) obtained by free-radical addition polymerization, when classified in a coordinate system by way of their average molecular weight M_{w} and their polydispersity, being situated in the area above a straight line which is defined by the linear equation y=1.25x+20 000 and has been shifted in y direction parallelwise by at least +3 000, the x axis denoting the weight-average molecular weight and the y axis the polydispersity times 10 000.

The invention further relates to the binders themselves and also to their use for moldings, mats or boards, for example, in particular for fibrous and particulate substrates such as fiber webs, glass fibers, rockwool, reclaimed cotton, natural fibers or synthetic fibers.

The consolidation of sheetlike fibrous structures, or fiber webs, is effected, for example, purely mechanically by needling or water jet consolidation of a wet-laid or air-laid web or by chemical consolidation of the webs with a polymeric binder. The binder is generally applied by impregnating, spraying or coating. To enhance the wet strength and heat resistance of the webs use is frequently made of binders comprising crosslinkers which give off formaldehyde. Alternatives to existing binders are sought by the skilled worker in order to avoid formaldehyde emissions.

U.S. Pat. No. 6,221,973 discloses a formaldehyde-free, crosslinkable aqueous composition comprising a polyacid, a polyol, and a phosphorus-containing reaction accelerant for use as binders for heat-resistant nonwovens, e.g., glass fibers.

EP 990 727 discloses binders for mineral fibers, comprising a low molecular mass polycarboxy polymer and a polyol, the pH of the binder being not greater than 3.5.

U.S. Pat. No. 5,932,665 discloses binders based on polycarboxy polymer, this system being curable at lower temperatures than in the case of comparable systems composed of homopolyacrylic acids, by setting of the molecular weight and of the copolymer composition.

EP 882 074 describes formaldehyde-free aqueous binders comprising an ethylenically unsaturated acid anhydride or an ethylenically unsaturated dicarboxylic acid and an alkanolamine as coating materials, impregnants and binders for fiber webs.

The binders described to date in the state of the art use either low or high molecular mass polycarboxylic acids, i.e., polycarboxylic acids having a molecular weight distribution which is typical of free-radical addition polymerizations. Substrates produced using high molecular mass binders have a high strength, a quality determined by means, for example, of tensile strength measurements. Low molecular mass binders based on polycarboxylic acid are distributed effectively on the substrates, since they possess high fluidities (as measured by dynamic mechanical analysis, determination of the dynamic storage modulus G′), but have deficiencies in the resulting strength properties.

It is an object of the present invention to provide binders for use for substrates such as moldings, mats, or boards, said binders combining high strengths with high fluidity.

We have found that this object is achieved by the use of formaldehyde-free aqueous binders having a broad molecular weight distribution for substrates and comprising
(A) from 0 to 100% by weight of an ethylenically unsaturated acid anhydride or ethylenically unsaturated dicarboxylic acid whose carboxylic acid groups can form an anhydride group, or mixtures thereof,
(B) from 100 to 0% by weight of an ethylenically unsaturated compound,
(C) at least one polyfunctional crosslinker or mixtures thereof,
(D) and from 1 to 80% by weight of an aqueous polymer dispersion, the polymers of A) and B) obtained by free-radical addition polymerization, when classified in a coordinate system by way of their average molecular weight M_{w} and their polydispersity, being situated in the area above a straight line which is defined by the linear equation y=1.25x+20 000 and has been shifted in y direction parallelwise by at least +3 000, the x axis denoting the weight-average molecular weight and the y axis the polydispersity times 10 000.

Surprisingly, the addition of the aqueous polymer dispersion (D) gives rise to binders having particularly good binder properties, particularly in respect of wet strength.

When the polycarboxylic acids of the invention with broad molecular weight distribution are used, the high molecular mass fractions of the binder ensure high strength in the substrates while the low molecular mass fractions at the same time guarantee high fluidity of the binder on the substrate.

The aqueous binder of the invention comprises a polymer A) containing from 0 to 100% by weight, preferably from 5 to 50% by weight, more preferably from 10 to 40% by weight of units of an ethylenically unsaturated acid anhydride or an ethylenically unsaturated dicarboxylic acid whose carboxylic groups can form an anhydride group.

Preferred acid anhydrides are dicarboxylic anhydrides. Suitable ethylenically unsaturated dicarboxylic acids are generally those having carboxylic acid groups on adjacent carbon atoms.

The carboxylic acids can also be present in the form of their salts.

Preferred monomers A) are maleic acid, fumaric acid, maleic anhydride, itaconic acid, 1,2,3,6-tetrahydrophthalic acid, 1,2,3,6-tetrahydrophthalic anhydride, their alkali metal salts and ammonium salts or mixtures thereof. Particular preference is given to maleic acid and maleic anhydride.

Monomers B) which can be used include for example the following:

monoethylenically unsaturated C₃ to C₁₀ monocarboxylic acids (monomers b₁), such as acrylic acid, methacrylic acid, ethylacrylic acid, allylacetic acid, crotonic acid, vinylacetic acid, maleic monoesters such as monomethyl maleate, their mixtures and their alkali metal salts and ammonium salts;
linear 1-olefins, branched-chain 1-olefins or cyclic olefins (monomers b₂), such as ethene, propene, butene, isobutene, pentene, cyclopentene, hexene, cyclohexene, octene, 2,4,4-trimethyl-1-pentene alone or mixed with 2,4,4-trimethyl-2-pentene, C₈-C₁₀ olefin, 1-dodecene, C₁₂-C₁₄ olefin, octadecene, 1-eicosene (C₂₀), C₂₀-C₂₄ olefin; oligoolefins prepared by metallocene catalysis and having a terminal double bond, such as oligopropene, oligohexene and oligooctadecene; and olefins prepared by cationic polymerization and having a high α-olefin fraction, such as polyisobutene;
vinyl and allyl alkyl ethers having 1 to 40 carbon atoms in the alkyl radical, it being possible for the alkyl radical to carry further substituents such as a hydroxyl group, an amino or dialkylamino group or one or more alkoxylate groups (monomers b₃), such as methyl vinyl ether, ethyl vinyl ether, propyl vinyl ether, isobutyl vinyl ether, 2-ethylhexyl vinyl ether, vinyl cyclohexyl ether, vinyl-4-hydroxybutyl ether, decyl vinyl ether, dodecyl vinyl ether, octadecyl vinyl ether, 2-(diethylamino)ethyl vinyl ether, 2-(di-n-butyl-amino)ethyl vinyl ether, methyl diglycol vinyl ether, and the corresponding allyl ethers and mixtures thereof;
acrylamides and alkyl-substituted acrylamides (monomers b₄), such as acrylamide, methacrylamide, N-tert-butylacrylamide, and N-methyl(meth)acrylamide;
monomers containing sulfo groups (monomers b₅), such as allylsulfonic acid, methallylsulfonic acid, styrenesulfonate, vinylsulfonic acid, allyloxybenzenesulfonic acid, 2-acrylamido-2-methylpropanesulfonic acid, their corresponding alkali metal salts or ammonium salts, or mixtures thereof;
C₁ to C₈ alkyl esters or C₁ to C₄ hydroxyalkyl esters of acrylic acid, methacrylic acid or maleic acid, or acrylic, methacrylic or maleic esters of C₁ to C₁₋₈ alcohols alkoxylated with from 2 to 50 mol of ethylene oxide, propylene oxide, butylene oxide or mixtures thereof (monomers b₆), such as methyl (meth)acrylate, ethyl (meth)acrylate, propyl (meth)acrylate, isopropyl (meth)acrylate, butyl (meth)acrylate, hexyl (meth)acrylate, 2-ethylhexyl (meth)acrylate, hydroxyethyl (meth)acrylate, hydroxypropyl (meth)acrylate, butane-1,4-diol monoacrylate, dibutyl maleate, ethyl diglycol acrylate, methyl polyglycol acrylate (11 EO), (meth)acrylic esters of C₁₃/C₁₅ oxo alcohol reacted with 3, 5, 7, 10 or 30 mol of ethylene oxide, or mixtures thereof;
alkylaminoalkyl (meth)acrylates or alkylaminoalkyl(meth)acrylamides or quaternization products thereof (monomers b₇), such as 2-(N,N-dimethylamino)ethyl (meth)acrylate, 3-(N,N-dimethylamino)propyl (meth)acrylate, 2-(N,N,N-trimethylammonio)ethyl (meth)acrylate chloride, 2-dimethylaminoethyl (meth)acrylamide, 3-dimethylamino-propyl (meth)acrylamide, and 3-trimethylammoniopropyl(meth)acrylamide chloride;
vinyl and allyl esters of C₁ to C₃₀ monocarboxylic acids (monomers b₈), such as vinyl formate, vinyl acetate, vinyl propionate, vinyl butyrate, vinyl valerate, vinyl 2-ethyl-hexanoate, vinyl nonoate, vinyl decanoate, vinyl pivalate, vinyl palmitate, vinyl stearate, and vinyl laurate.

Further possible monomers b₉ include the following:

N-vinylformamide, N-vinyl-N-methylformamide, styrene, α-methylstyrene, 3-methyl-styrene, butadiene, N-vinylpyrrolidone, N-vinylimidazole, 1-vinyl-2-methylimidazole, 1-vinyl-2-methylimidazoline, N-vinylcaprolactam, acrylonitrile, methacrylonitrile, allyl alcohol, 2-vinylpyridine, 4-vinylpyridine, diallyidimethylammonium chloride, vinylidene chloride, vinyl chloride, acrolein, methacrolein, and vinylcarbazole and mixtures thereof.

As well as monomers A), the polymer preferably additionally comprises monomers (B) in amounts of from 50 to 95%, more preferably from 60 to 90%, by weight.

Preferred monomers are acrylic acid, methacrylic acid, esters of acrylic or methacrylic acid (e.g., methyl (meth)acrylate, ethyl (meth)acrylate, butyl (meth)acrylate), ethene, propene, butene, isobutene, cyclopentene, methyl vinyl ether, ethyl vinyl ether, acrylamide, 2-acrylamido-2-methylpropanesulfonic acid, vinyl acetate, styrene, butadiene, acrylonitrile, monomethyl maleate or mixtures thereof.

Particular preference is given to acrylic acid, methacrylic acid, methyl (meth)acrylate, ethyl (meth)acrylate, butyl (meth)acrylate, ethene, acrylamide, styrene and acrylonitrile, monomethyl maleate or mixtures thereof.

Very particular preference is given to acrylic acid, methacrylic acid and methyl (meth)acrylate, ethyl (meth)acrylate, butyl (meth)acrylate, monomethyl maleate or mixtures thereof.

The polymers can be prepared according to customary polymerization processes, for example by bulk, emulsion, suspension, dispersion, precipitation or solution polymerization. The polymerization processes stated are preferably operated in the absence of oxygen, preferably in a stream of nitrogen. For all polymerization methods the customary apparatus is used, examples being stirred tanks, stirred tank cascades, autoclaves, tube reactors, and compounders. It is preferred to operate in accordance with the method of solution, emulsion, precipitation or suspension polymerization. The methods of solution polymerization and of emulsion polymerization are particularly preferred. The polymerization can be performed in solvents or diluents, such as toluene, o-xylene, p-xylene, cumene, chlorobenzene, ethylbenzene, technical-grade mixtures of alkyl aromatics, cyclohexane, technical-grade aliphatics mixtures, acetone, cyclohexanone, tetrahydrofuran, dioxane, glycols and glycol derivatives, polyalkylene glycols and derivatives thereof, diethyl ether, tert-butyl methyl ether, methyl acetate, isopropanol, ethanol, water or mixtures such as, for example isopropanol/water mixtures. The preferred solvent or diluent is water with or without fractions of up to 60% by weight of alcohols or glycols. The use of water is particularly preferred.

The polymerization can be conducted at temperatures from 20 to 300° C., preferably from 60 to 200° C. Depending on the choice of polymerization conditions it is possible to obtain weight-average molecular weights of, for example, from 800 to 5 000 000, in particular from 1 000 to 1 000 000. The weight-average molecular weights M_{w} are preferably above 3 000. Weight-average molecular weights of from 3 000 to 600 000 are particularly preferred. M_{w} is determined by gel permeation chromatography (detailed description in Examples).

The polymers comprising the monomers A) and B), when classified in a coordinate system by way of their average molecular weight M_{w} and their polydispersity, are situated in the area above a straight line which is defined by the linear equation y=1.25x+20 000 and has been shifted in the y direction parallelwise by +5 000, the x axis denoting the weight-average molecular weight and the y axis the polydispersity times 10 000.

The polymerization is preferably conducted in the presence of compounds which form free radicals. These compounds are required in amounts of up to 30%, preferably from 0.05 to 15%, more preferably from 0.2 to 8% by weight, based on the monomers used in the polymerization. In the case of multicomponent initiator systems (redox initiator systems, for example) the above weight figures are based on the sum total of the components.

Examples of suitable polymerization initiators include peroxides, hydroperoxides, peroxodisulfates, percarbonates, peroxy esters, hydrogen peroxide, and azo compounds. Examples of initiators, which may be water-soluble or else water-insoluble, are hydrogen peroxide, dibenzoyl peroxide, dicyclohexyl peroxodicarbonate, dilauroyl peroxide, methyl ethyl ketone peroxide, di-tert-butyl peroxide, acetylacetone peroxide, tert-butyl hydroperoxide, cumene hydroperoxide, tert-butyl perneodecanoate, tert-amyl perpivalate, tert-butyl perpivalate, tert-butyl perneohexanoate, tert-butyl per-2-ethylhexanoate, tert-butyl perbenzoate, lithium, sodium, potassium and ammonium peroxodisulfate, azodiisobutyronitrile, 2,2′-azobis(2-amidinopropane) dihydrochloride, 2-(carbamoylazo)isobutyronitrile and 4,4-azobis(4-cyanovaleric acid).

The initiators can be employed alone or in a mixture with one another, examples being mixtures of hydrogen peroxide and sodium peroxodisulfate. For polymerization in an aqueous medium it is preferred to use water-soluble initiators.

It is equally possible to use the known redox initiator systems as polymerization initiators. Such redox initiator systems comprise at least one peroxide compound in combination with a redox coinitiator, examples being reducing sulfur compounds, such as bisulfites, sulfites, thiosulfates, dithionites and tetrathionates of alkali metals and ammonium compounds. For instance, combinations of peroxodisulfates with alkali metal or ammonium hydrogensulfites can be used, e.g., ammonium peroxodisulfate and ammonium disulfite. The amount of the peroxide compound relative to the redox coinitiator is from 30:1 to 0.05:1.

In combination with the initiators or redox initiator systems it is possible in addition to use transition metal catalysts, examples being salts of iron, cobalt, nickel, copper, vanadium, and manganese. Examples of suitable salts include iron(II) sulfate, cobalt(II) chloride, nickel(II) sulfate, and copper(I) chloride. Based on monomers, the reducing transition metal salt is used at a concentration of from 0.1 to 1 000 ppm. For instance, combinations of hydrogen peroxide with iron(II) salts can be used, such as from 0.5 to 30% of hydrogen peroxide and from 0.1 to 500 ppm of Mohr's salt.

Polymerization in organic solvents, too, can be carried out using redox coinitiators and/or transition metal catalysts in combination with the abovementioned initiators, examples of such coinitiators and/or catalysts being benzoin, dimethylaniline, ascorbic acid, and organic-solvent-soluble complexes of heavy metals such as copper, cobalt, iron, manganese, nickel, and chromium. The amounts of redox coinitiators or transition metal catalysts normally used here are customarily from about 0.1 to 1 000 ppm, based on the amounts of monomers used.

If the polymerization of the reaction mixture is started at the lower limit of the suitable temperature range for the polymerization and subsequently completed at a higher temperature then it is advantageous to use at least two different initiators which decompose at different temperatures, so that a sufficient concentration of free radicals is available within each temperature interval.

The initiator can also be added in stages, or the rate of initiator addition can be varied over time.

To prepare polymers having a low average molecular weight it is frequently advantageous to conduct the copolymerization in the presence of regulators. For this purpose it is possible to use customary regulators, such as organic SH-comprising compounds, such as 2-mercaptoethanol, 2-mercaptopropanol, mercaptoacetic acid, tert-butyl mercaptan, n-octyl mercaptan, n-dodecyl mercaptan and tert-dodecyl mercaptan, C₁ to C₄ aldehydes, such as formaldehyde, acetaldehyde, propionaldehyde, hydroxylammonium salts such as hydroxylammonium sulfate, formic acid, sodium bisulfite or hypophosphorous acid or the salts thereof, or isopropanol. The polymerization regulators are generally used in amounts of from 0.1 to 20% by weight, based on the monomers. The average molecular weight can also be influenced by the choice of appropriate solvent. For instance, polymerization in the presence of diluents containing benzylic hydrogen atoms, or in the presence of secondary alcohols such as isopropanol, for example, leads to a reduction in the average molecular weight, as a result of chain transfer.

Polymers of low molecular weight are also obtained by varying the temperature and/or the concentration of initiator.

In order to prepare higher molecular mass copolymers it is frequently advantageous to operate the polymerization in the presence of crosslinkers. Such crosslinkers are compounds having two or more ethylenically unsaturated groups, such as, for example, diacrylates or dimethacrylates of at least dihydric saturated alcohols, such as ethylene glycol diacrylate, ethylene glycol dimethacrylate, 1,2-propylene glycol diacrylate, 1,2-propylene glycol dimethacrylate, butane-1,4-diol diacrylate, butane-1,4-diol dimethacrylate, hexanediol diacrylate, hexanediol dimethacrylate, neopentyl glycol diacrylate, neopentyl glycol dimethacrylate, 3-methylpentanediol diacrylate and 3-methylpentanediol dimethacrylate. The acrylic and methacrylic esters of alcohols having more than 2 OH groups can also be used as crosslinkers, e.g., trimethylol-propane triacrylate or trimethylolpropane trimethacrylate. A further class of crosslinkers are diacrylates or dimethacrylates of polyethylene glycols or polypropylene glycols having molecular weights of from 200 to 9 000 in each case. Polyethylene glycols and polypropylene glycols used for preparing the diacrylates or dimethacrylates preferably have a molecular weight of from 400 to 2 000 in each case. As well as the homopolymers of ethylene oxide and/or propylene oxide it is also possible to use block copolymers of ethylene oxide and propylene oxide or copolymers of ethylene oxide and propylene oxide containing the ethylene and propylene oxide units in random distribution. The oligomers of ethylene oxide and/or propylene oxide are suitable as well for preparing the crosslinkers, e.g., diethylene glycol diacrylate, diethylene glycol dimethacrylate, triethylene glycol diacrylate, triethylene glycol dimethacrylate, tetraethylene glycol diacrylate and/or tetraethylene glycol dimethacrylate.

Suitable crosslinkers further include vinyl acrylate, vinyl methacrylate, vinyl itaconate, divinyl adipate, butanediol divinyl ether, trimethylolpropane trivinyl ether, allyl acrylate, allyl methacrylate, pentaerythritol triallyl ether, triallylsucrose, pentaallylsucrose, pentaallylsaccharose, methylenebis(meth)acrylamide, divinylethyleneurea, divinylpropyleneurea, divinylbenzene, divinyidioxane, triallylcyanurate, tetraallylsilane, tetravinylsilane, and bis- or polyacryloylsiloxanes (e.g., Tegomers® from Th. Goldschmidt AG). The crosslinkers are used preferably in amounts of from 10 ppm to 5% by weight, based on the monomers to be polymerized.

If the method of emulsion, precipitation, suspension or dispersion polymerization is used, it can be advantageous to stabilize the polymer droplets or polymer particles by means of surface-active auxiliaries. Typically emulsifiers or protective colloids are used for this purpose. Suitable emulsifiers include anionic, nonionic, cationic, and amphoteric emulsifiers. Examples of anionic emulsifiers are alkylbenzenesulfonic acids, sulfonated fatty acids, sulfosuccinates, fatty alcohol sulfates, alkylphenol sulfates, and fatty alcohol ether sulfates. Examples of nonionic emulsifiers that can be used include alkylphenol ethoxylates, primary alcohol ethoxylates, fatty acid ethoxylates, alkanolamide ethoxylates, fatty amine ethoxylates, EO/PO block copolymers, and alkylpolyglucosides. Examples of cationic and amphoteric emulsifiers used include quaternized amine alkoxylates, alkylbetaines, alkylamidobetaines, and sulfobetaines.

Examples of typical protective colloids include cellulose derivatives, polyethylene glycol, polypropylene glycol, copolymers of ethylene glycol and propylene glycol, polyvinyl acetate, polyvinyl alcohol polyvinyl ethers, starch and starch derivatives, dextran, polyvinylpyrrolidone, polyvinylpyridine, polyethyleneimine, polyvinylimidazole, polyvinylsuccinimide, polyvinyl-2-methylsuccinimide, polyvinyl-1,3-oxazolid-2-one, polyvinyl-2-methylimidazoline, and maleic acid or maleic anhydride copolymers, as described in DE 2 501 123, for example.

The emulsifiers or protective colloids are customarily used in concentrations of from 0.05 to 20% by weight, based on the monomers.

If polymerization is carried out in aqueous solution or dilution then the monomers can be wholly or partly neutralized with bases prior to or during the polymerization. Examples of suitable bases include alkali metal and alkaline earth metal compounds such as sodium hydroxide, potassium hydroxide, calcium hydroxide, magnesium oxide, sodium carbonate; ammonia; primary, secondary, and tertiary amines, such as ethylamine, propylamine, monoisopropylamine, monobutylamine, hexylamine, ethanolamine, dimethylamine, diethylamine, di-n-propylamine, tributylamine, triethanolamine, dimethoxyethylamine, 2-ethoxyethylamine, 3-ethoxypropylamine, dimethylethanolamine, diisopropanolamine or morpholine.

Neutralization can also be effected using polybasic amines, such as ethylenediamine, 2-diethylaminoethylamine, 2,3-diaminopropane, 1,2-propylenediamine, dimethylaminopropylamine, neopentanediamine, hexamethylenediamine, 4,9-dioxadodecane-1,12-diamine, polyethyleneimine or polyvinylamine, for example.

For partial or complete neutralization of the ethylenically unsaturated carboxylic acids before or during the polymerization it is preferred to use ammonia, triethanolamine, and diethanolamine.

With particular preference the ethylenically unsaturated carboxylic acids are not neutralized prior to or during the polymerization. With preference neither is any neutralizing agent, apart from the alkanolamine C), added after the polymerization. The polymerization can be conducted continuously or batchwise in accordance with a multiplicity of variants. It is customary to introduce a fraction of the monomers as an initial charge, where appropriate in a suitable diluent or solvent and where appropriate in the presence of an emulsifier, protective colloid or further auxiliaries, to render the atmosphere inert, and to raise the temperature until the desired polymerization temperature is reached. However, the initial charge may also be a suitable diluent alone. The free-radical initiator, further monomers, and other auxiliaries, such as regulators or crosslinkers, for example, each in a diluent, if necessary, are metered in over a defined period of time. The feed times may differ in length. For example, the initiator feed may be run in over a longer time than that chosen for the monomer feed.

The polymers having a broad molecular weight distribution can also be prepared in situ in one step, by first synthesizing the low molecular mass fraction (at a defined initiator concentration/temperature) and, after adding 0-100% of the monomers, lowering the concentration of initiator in the reaction mixture and/or reducing the temperature (gradually or continuously); or the multimodal polymers can be prepared in situ in one step by first synthesizing the high molecular mass fraction (at defined initiator concentration/temperature) and, following the addition of 100-0% of the monomers, raising the initiator concentration in the reaction mixture and/or raising the temperature.

If the polymer is obtained in water in accordance with a solution polymerization process, there is usually no need to separate off the solvent. If it is nonetheless desired to isolate the polymer, this can be done by spray drying, for example.

If the polymer is prepared by a solution, precipitation or suspension polymerization method in a steam-volatile solvent or solvent mixture, the solvent can be removed by introducing steam in order thus to obtain an aqueous solution or dispersion. The polymer can also be separated from the organic diluent by a drying operation.

The polymers of A) and B) are preferably in the form of an aqueous dispersion or solution having solids contents of preferably from 10 to 80% by weight, in particular from 40 to 65% by weight.

Polymer A) can also be obtained by grafting maleic acid or maleic anhydride, or a monomer mixture comprising maleic acid or maleic anhydride, onto a graft base. Examples of suitable graft bases are monosaccharides, oligosaccharides, modified polysaccharides, and alkyl polyglycol ethers. Graft polymers of this kind are described in DE 4 003 172 and EP 116 930, for example.

The polyfunctional crosslinkers of component C) are, for example, alkanolamines having at least two OH groups. Preference is given to alkanolamines of the formula I

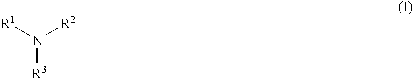

where R¹ is a hydrogen atom, a C₁-C₁₀ alkyl group or a C₁-C₁₀ hydroxyalkyl group and R² and R³ are each a C₁-C₁₀ hydroxyalkyl group.

With particular preference R² and R³ independently of one another are each a C₂-C₅ hydroxyalkyl group and R¹ is a hydrogen atom, a C₁-C₅ alkyl group or a C₂-C₅ hydroxyalkyl group.

Examples of compounds of the formula I include diethanolamine, triethanolamine, diisopropanolamine, triisopropanolamine, methyldiethanolamine, butyldiethanolamine, and methyldiisopropanolamine. Triethanolamine is particularly preferred.

Polyfunctional crosslinkers C) can also be difunctional or polyfunctional alcohols, such as glycerol, methylolated melamines or phenols, for example.

Further polyfunctional crosslinkers which can be used as component C) are described in EP 902 796, examples being trimethylolpropane, pentaerythritol, neopentyl glycol, glucose, sorbitol, hexanediol, lysine, and polyvinyl alcohol.

As component C) it is preferred to use alkanolamines, with particular preference triethanolamine.

The aqueous polymer dispersion D) comprehends, for example, straight acrylate dispersions, styrene-acrylate dispersions, XSB dispersions, polyurethane dispersions, or a modified dispersion comprising polycarboxylic acid with alcohol as crosslinker component.

Preferably the polymer dispersion D comprehends a modified dispersion comprising polycarboxylic acid with alcohol as crosslinker component, comprising dispersed polymer particles of at least one polymer A1 obtainable by free-radical emulsion polymerization in the presence of a polymer A2 synthesized from
from 50 to 99.5% by weight of at least one ethylenically unsaturated monocarboxylic and/or dicarboxylic acid,
from 0.5 to 50% by weight of at least one ethylenically unsaturated compound selected from the esters of ethylenically unsaturated monocarboxylic acids and the monoesters and diesters of ethylenically unsaturated dicarboxylic acids with an amine containing at least one hydroxyl group,
up to 20% by weight of at least one further monomer.

These dispersions are described in EP 1 240 205, which by reference is explicitly made part of the disclosure content of the present invention as well.

In connection with the monomer components of the polymer A1, alkyl below is preferably straight-chain or branched C₁-C₂₂ alkyl radicals, especially C₁-C₁₂, and with particular preference C₁-C₆, alkyl radicals, such as methyl, ethyl, n-propyl, n-butyl, sec-butyl, tert-butyl, n-pentyl, n-hexyl, 2-ethylhexyl, n-dodecyl or n-stearyl. Hydroxyalkyl is preferably hydroxy-C₁-C₆ alkyl, in which the alkyl radicals may be straight-chain or branched, and in particular is 2-hydroxyethyl, 2- or 3-hydroxypropyl, 2-methyl-2-hydroxypropyl, and 4-hydroxybutyl.

Cycloalkyl is preferably C₅-C₇ cyclohexyl, especially cyclopentyl and cyclohexyl.

Aryl is preferably phenyl or naphthyl.

The polymer A1 is a free-radical emulsion polymer. It may be prepared using all monomers that can be polymerized by free-radical polymerization. In general, the polymer is synthesized from
from 80 to 100% by weight, preferably from 85 to 99.9% by weight, based on the overall weight of the monomers for the polymer, of at least one ethylenically unsaturated principal monomer, and
from 0 to 20% by weight, preferably from 0.1 to 15% by weight, based on the overall weight of the monomers for the polymer, of at least one ethylenically unsaturated comonomer.

The principal monomer is preferably selected from
esters of preferably C₃-C₆ α,β-monoethylenically unsaturated mono- or dicarboxylic acid, such as acrylic acid, methacrylic acid, maleic acid, fumaric acid, and itaconic acid, with C₁-C₁₂, preferably C₁-C₈ alkanols. Particular such esters are methyl, ethyl, n-butyl, isobutyl, tert-butyl, n-pentyl, isopentyl, and 2-ethylhexyl acrylate and/or methacrylate;
vinylaromatic compounds, preferably styrene, α-methylstyrene, o-chlorostyrene, vinyltoluenes, and mixtures thereof;
vinyl esters of C₁-C₁₈ mono- or dicarboxylic acids, such as vinyl acetate, vinyl propionate, vinyl n-butyrate, vinyl laurate and/or vinyl stearate;
butadiene;
linear 1-olefins, branched-chain 1-olefins or cyclic olefins, such as ethene, propene, butene, isobutene, pentene, cyclopentene, hexene, and cyclohexene, for example. Also suitable are oligoolefins prepared using metallocene catalysis and having a terminal double bond, such as oligopropene or oligohexene, for example;
acrylonitrile, methacrylonitrile;
vinyl and allyl alkyl ethers having 1 to 40 carbon atoms in the alkyl radical, said alkyl radical possibly carrying further substituents such as one or more hydroxyl groups, one or more amino or diamino groups, or one or more alkoxylated groups, examples being methyl vinyl ether, ethyl vinyl ether, propyl vinyl ether, and 2-ethylhexyl vinyl ether, isobutyl vinyl ether, vinyl cyclohexyl ether, vinyl 4-hydroxybutyl ether, decyl vinyl ether, dodecyl vinyl ether, octadecyl vinyl ether, 2-(diethylamino)ethyl vinyl ether, 2-(di-n-butyl-amino)ethyl vinyl ether, methyldiglycol vinyl ether, and the corresponding allyl ethers, and/or mixtures thereof.

Particularly preferred principal monomers are styrene, methyl methacrylate, n-butyl acrylate, ethyl acrylate, 2-ethylhexyl acrylate, vinyl acetate, ethene, and butadiene.

The comonomer is preferably selected from
ethylenically unsaturated mono- or dicarboxylic acids or their anhydrides, preferably acrylic acid, methacrylic acid, methacrylic anhydride, maleic acid, maleic anhydride, fumaric acid and/or itaconic acid;
acrylamides and alkyl-substituted acrylamides, such as acrylamide, methacrylamide, N,N-dimethylacrylamide, N-methylolmethacrylamide, N-tert-butylacrylamide, N-methylmethacrylamide and mixtures thereof;
sulfo-functional monomers, such as allylsulfonic acid, methallylsulfonic acid, styrenesulfonic acid, vinylsulfonic acid, 2-acrylamido-2-methylpropane-sulfonic acid, allyloxybenzenesulfonic acid, their corresponding alkali metal or ammonium salts, and mixtures thereof, and also sulfopropyl acrylate and/or sulfopropyl methacrylate;
C₁-C₄ hydroxyalkyl esters of C₃-C₆ mono- or dicarboxylic acids, especially of acrylic acid, methacrylic acid or maleic acid, or their derivatives alkoxylated with from 2 to 50 mol of ethylene oxide, propylene oxide, butylene oxide or mixtures thereof, or esters of the abovementioned acids with C₁-C₁₈ alcohols alkoxylated with from 2 to 50 mol of ethylene oxide, propylene oxide, butylene oxide or mixtures thereof, examples being hydroxyethyl acrylate, hydroxyethyl methacrylate, hydroxypropyl acrylate, hydroxypropyl methacrylate, 1,4-butanediol monoacrylate, ethyldiglycol acrylate, methylpolyglycol acrylate (11 EO), (meth)acrylic esters of C₁₃/C₁₅ OXO alcohol reacted with 3, 5, 7, 10 or 30 mol of ethylene oxide, and mixtures thereof;
vinylphosphonic acids and their salts, dimethyl vinylphosphonate, and other phosphorus monomers;
alkylaminoalkyl (meth)acrylates or alkylaminoalkyl(meth)acrylamides or quaternization products thereof, such as, for example, 2-(N,N-dimethyl-amino)ethyl (meth)acrylate, 2-(N,N,N-trimethylammonium)ethyl methacrylate chloride, 3-(N,N-dimethylamino)propyl (meth)acrylate, 2-dimethylaminoethyl(meth)acrylamide, 3-dimethylaminopropyl(meth)-acrylamide, 3-trimethylammoniumpropyl(meth)acrylamide chloride and mixtures thereof;
allyl esters of C₁-C₃₀ monocarboxylic acids;
N-vinyl compounds, such as N-vinylformamide, N-vinyl-N-methylformamide, N-vinylpyrrolidone, N-vinylimidazole, 1-vinyl-2-methylimidazole, 1-vinyl-2-methylimidazoline, 2-vinylpyridine, 4-vinylpyridine, N-vinylcarbazole and/or N-vinylcaprolactam;
diallyldimethylammonium chloride, vinylidene chloride, vinyl chloride, acrolein, methacrolein;
monomers containing 1,3-diketo groups, such as, for example, acetoacetoxyethyl (meth)acrylate or diacetoneacrylamide, monomers containing urea groups, such as ureidoethyl (meth)acrylate, acrylamidoglycolic acid, and methyl methacrylamidoglycolate;
monomers comprising silyl groups, such as, for example, trimethoxysilyl-propyl methacrylate;
monomers comprising glycidyl groups, such as, for example, glycidyl methacrylate.

Particularly preferred comonomers are hydroxyethyl acrylate, hydroxypropyl acrylate, hydroxybutyl acrylate, hydroxyethyl methacrylate and mixtures thereof. Very particular preference is given to hydroxyethyl acrylate and hydroxyethyl methacrylate, especially in amounts of from 2 to 20% by weight, based on the overall monomer A1.

The polymer A2 comprises from 50 to 99.5% by weight, preferably from 70 to 99% by weight, of structural elements derived from at least one ethylenically unsaturated mono- or dicarboxylic acid. If desired, these acids may also be present partly or fully in the form of a salt in the polymer. The acidic form is preferred.

The polymer A2 is preferably soluble in water to the extent of more than 10 g/l (25° C.).

Ethylenically unsaturated carboxylic acids which may be used have already been mentioned above in connection with the polymer A1. Preferred carboxylic acids are C₃ to C₁₀ monocarboxylic acids and C₄ to C₈ dicarboxylic acids, especially acrylic acid, methacrylic acid, crotonic acid, fumaric acid, maleic acid, 2-methylmaleic acid and/or itaconic acid. Particular preference is given to acrylic acid, methacrylic acid, maleic acid and mixtures thereof. In the preparation of the polymer A2 it is of course also possible to use, instead of or together with the acids, their anhydrides, such as maleic anhydride, acrylic anhydride or methacrylic anhydride.

The polymer A2 further comprises from 0.5 to 50% by weight, preferably from 1 to 30% by weight, of at least one ethylenically unsaturated compound selected from esters of ethylenically unsaturated monocarboxylic acids and monoesters and diesters of ethylenically unsaturated dicarboxylic acids with at least one hydroxyl-containing amine, in copolymerized form.

The polymer A2 is preferably in the form of a comb polymer having covalently bonded amine side chains.

Monocarboxylic acids suitable as components of the esters are the above-mentioned C₃ to C₁₀ monocarboxylic acids, especially acrylic acid, methacrylic acid, crotonic acid and mixtures thereof.

Dicarboxylic acids suitable as components of the monoesters and diesters are the abovementioned C₄ to C₈ dicarboxylic acids, especially fumaric acid, maleic acid, 2-methylmaleic acid, itaconic acid, and mixtures thereof.

The amine having at least one hydroxyl group is preferably selected from secondary and tertiary amines containing at least one C₆ to C₂₂ alkyl, C₆ to C₂₂ alkenyl, aryl-C₆ to C₂₂ alkyl or aryl-C₆ to C₂₂ alkenyl radical, it being possible for the alkenyl group to have 1, 2 or 3 nonadjacent double bonds.

The amine is preferably hydroxyalkylated and/or alkoxylated. Alkoxylated amines preferably have one or two alkylene oxide residues with terminal hydroxyl groups. Preferably, the alkylene oxide residues each have from 1 to 100, preferably from 1 to 50, identical or different alkylene oxide units, distributed randomly or in the form of blocks. Preferred alkylene oxides are ethylene oxide, propylene oxide and/or butylene oxide. Ethylene oxide is particularly preferred.

The polymer A2 preferably comprises an incorporated unsaturated compound based on an amine component comprising at least one amine of the formula

R^{c}NR^{a}R^{b}

where
R^{c} is C₆ to C₂₂ alkyl, C₆ to C₂₂ alkenyl, aryl-C₆-C₂₂ alkyl or aryl-C₆-C₂₂ alkenyl, it being possible for the alkenyl radical to have 1, 2 or 3 nonadjacent double bonds,
R^{a} is hydroxy-C₁-C₆ alkyl or a radical of the formula II

—(CH₂CH₂O)ₓ(CH₂CH(CH₃)O)_{y}—H (II)
where
in the formula II the sequence of the alkylene oxide units is arbitrary and x and y independently of one another are integers from 0 to 100, preferably from 0 to 50, the sum of x and y being >1,
R^{b} is hydrogen, C₁ to C₂₂ alkyl, hydroxy-C₁-C₆ alkyl, C₆ to C₂₂ alkenyl, aryl-C₆-C₂₂ alkyl, aryl-C₆-C₂₂ alkenyl or C₅ to C₈ cycloalkyl, it being possible for the alkenyl radical to have 1, 2 or 3 nonadjacent double bonds, or R^{b} is a radical of the formula III

—(CH₂CH₂O)ᵥ(CH₂CH(CH₃)O)_{w}—H (III)
where
in the formula III the sequence of the alkylene oxide units is arbitrary and v and w independently of one another are integers from 0 to 100, preferably from 0 to 50.

Preferably R^{c} is C₈ to C₂₀ alkyl or C₈ to C₂₀ alkenyl, it being possible for the alkenyl radical to have 1, 2 or 3 nonadjacent double bonds. R^{c} is preferably the hydrocarbon radical of a saturated or mono- or polyunsaturated fatty acid. Preferred radicals R^{c} are, for example, n-octyl, ethylhexyl, undecyl, lauryl, tridecyl, myristyl, pentadecyl, palmityl, margarinyl, stearyl, palmitoleinyl, oleyl and linolyl.

With particular preference, the amine component comprises an alkoxylated fatty amine or an alkoxylated fatty amine mixture. The ethoxylates are particularly preferred. Use is made in particular of alkoxylates of amines based on naturally occurring fatty acids, such as tallow fatty amines, for example, which comprise predominantly saturated and unsaturated C₁₄, C₁₆ and C₁₈ alkylamines, or cocoamines, comprising saturated, mono- and diunsaturated C₆-C₂₂, preferably C₁₂-C₁₄ alkylamines. Amine mixtures suitable for alkoxylation are, for example, various Armeen® grades from Akzo or Noram® grades from Ceca.

Examples of suitable commercially available alkoxylated amines are the Noramox® grades from Ceca, preferably ethoxylated oleyl-amines, such as Noramox® 15 (5 EO units), and the products from BASF AG marketed under the brand name Lutensol® FA.

Copolymerization of the abovementioned esters, monoesters and diesters generally brings about pronounced stabilization of the polymer dispersion D. The polymer dispersion reliably retains the colloidal stability of the latex particles on dilution with water or dilute electrolytes or surfactant solutions.

The esterification for preparing the above-described esters, monoesters and diesters takes place in accordance with customary techniques known to the skilled worker. To prepare esters of unsaturated monocarboxylic acids, the free acids or suitable derivatives, such as anhydrides, halides, e.g., chlorides, and (C₁ to C₄) alkyl esters may be used. The preparation of monoesters of unsaturated dicarboxylic acids takes place preferably starting from the corresponding dicarboxylic anhydrides. The reaction is preferably effected in the presence of a catalyst, such as a dialkyl titanate or an acid, such as sulfuric acid, toluenesulfonic acid, or methanesulfonic acid, for example. The reaction takes place generally at reaction temperatures from 60 to 200° C. In accordance with one appropriate embodiment, the reaction takes place in the presence of an inert gas, such as nitrogen. Water formed during the reaction may be removed from the reaction mixture by means of appropriate measures, such as distillation. The reaction may take place if desired in the presence of customary polymerization inhibitors. Essentially, the esterification reaction may be conducted to completion or just to a partial conversion. If desired, one of the ester components, preferably the hydroxyl-containing amine, may be used in excess. The extent of esterification may be determined by means of infrared spectroscopy.

In one preferred embodiment, the unsaturated esters, monoesters or diesters are prepared and further reacted to the polymers A2 used in accordance with the invention without isolation of the esters, the two reactions preferably taking place in succession in the same reaction vessel.

To prepare the polymers A2 it is preferred to use a reaction product of a dicarboxylic anhydride, preferably maleic anhydride, and one of the above-described hydroxyl-containing amines.

In addition to the carboxylic acid and the ester, monoester and/or diester constituents, the polymer A2 may also comprise in copolymerized form from 0 to 20% by weight, preferably from 0.1 to 10% by weight, of other monomers. Monomers which may be used are the monomers specified in connection with polymer A1, particular preference being given to vinylaromatic compounds, such as styrene, olefins, an example being ethylene, or (meth)acrylic esters such as methyl (meth)acrylate, ethyl (meth)acrylate, n-butyl (meth)acrylate, 2-ethylhexyl (meth)acrylate, and mixtures thereof.

The polymers A2 are prepared preferably by free-radical polymerization in bulk or in solution. Examples of suitable solvents for the solvent polymerization are water, water-miscible organic solvents such as alcohols and ketones, examples being methanol, ethanol, n-propanol, isopropanol, n-butanol, acetone, methyl ethyl ketone, etc., and mixtures thereof. Examples of suitable polymerization initiators are peroxides, hydroperoxides, peroxodisulfates, percarbonates, peroxo esters, hydrogen peroxide and azo compounds, as described in more detail below for the preparation of the polymer dispersions of the invention. If desired, the polymers A2 may be prepared separately and isolated and/or purified by a conventional method. Preferably, the polymers A2 are prepared directly before the preparation of the polymer dispersions of the invention and they are used without isolation for the dispersion polymerization.

The polymers A2 may advantageously also be prepared by means of polymer-analogous reaction. For this purpose a polymer comprising from 80 to 100% by weight of at least one incorporated ethylenically unsaturated mono- and/or dicarboxylic acid and from 0 to 20% by weight of the incorporated abovementioned other polymers may be reacted with at least one hydroxyl-containing amine.

Suitable ethylenically unsaturated mono- and dicarboxylic acids are those mentioned above as components of the polymers A1 and A2. Suitable amines having at least one hydroxyl group are likewise as mentioned above. In the polymer suitable for polymer-analogous reaction, the acids may, if desired, be present fully or partly in the form of a derivative, preferably a C₁ to C₆ alkyl ester.

Preparing the polymers A2 by means of polymer-analogous reaction is preferably done in an appropriate nonaqueous solvent or in bulk. In the case of the reaction in bulk, the amine component may if desired be used in excess, so as to act as solvent. Preferred solvents are those which form an azeotrope with water and so make it easy to remove the water formed during the reaction. The reaction preferably takes place in the presence of an esterification catalyst, as described above. The reaction temperature is preferably in a range from 100 to 200° C. Water formed during the reaction may be removed by means of appropriate measures, such as distillation, for example.

The weight ratio of polymer A1 to polymer A2, based on solids, is preferably in the range from 7:1 to 1:7, in particular from 3:1 to 1:3.

In addition to the polymers A1 and A2, the latices of the invention may further comprise from 0 to 50% by weight, preferably from 0.1 to 40% by weight, based on the polymer A2, of at least one surface-active, alkoxylated, preferably ethoxylated or propoxylated, alkylamine. Preferred alkylamines are the alkylamines of the formula R^{c}NR^{a}R^{b}, as defined above, which are also present in the polymer A2, particular preference being given to alkylamines of the formula

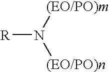

where R is an alkyl, alkenyl or alkylvinyl radical having at least 6 carbon atoms and m and n independently of one another are ≧1. Preferred radicals R have 8 to 22 carbon atoms.

The alkoxylated alkylamines comprised in the polymer A2, and the additional alkylamine crosslinkers, may be identical or different compounds.

If desired, the polymer dispersion of the invention may comprise further crosslinkers, an example being an amine or amide crosslinker having at least two hydroxyl groups. Particularly suitable crosslinkers are the alkanolamines disclosed in DE 197 29 161, which are hereby made part of the disclosure content of the present invention by reference.

Appropriate crosslinkers further include preferably β-hydroxyalkylamines of the formula

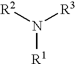

where R¹ is a hydrogen atom, a C₁ to C₁₀ alkyl group, a C₁ to C₁₀ hydroxyalkyl group, or a radical of the formula IV

—(CH₂CH₂O)ₓ(CH₂CH(CH₃)O)_{y}—H (IV)

where
in the formula IV the sequence of the alkylene oxide units is arbitrary and x and y independently of one another are integers from 0 to 100, the sum of x and y being >1, and R² and R³ independently of one another are a C₁ to C₁₀ hydroxyalkyl group.

With particular preference, R² and R³ independently of one another are a C₂ to C₅ hydroxyalkyl group and R¹ is a hydrogen atom, a C₁ to C₅ alkyl group or a C₂ to C₅ hydroxyalkyl group.

Particular preference is given to diethanolamine, triethanolamine, diisopropanolamine, triisopropanolamine, methyldiethanolamine, butyldiethanolamine and methyldiisopropanolamine, especially triethanolamine.

Further preferred β-hydroxyalkylamines are the amines disclosed as component A in DE 196 21 573, which is hereby made part of the disclosure content of the present invention by reference. They include preferably linear or branched aliphatic compounds containing per molecule at least two functional amino groups of type (a) or (b) where R is hydroxyalkyl and R′ is alkyl, preferably a compound of formula I

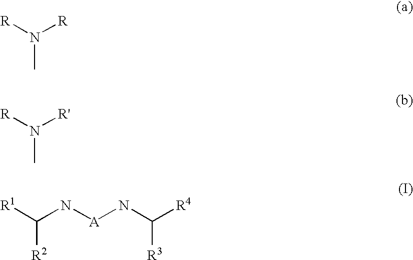

where
A is C₂-C₁₈ alkylene substituted or unsubstituted by one or more groups selected independently of one another from alkyl, hydroxyalkyl, cycloalkyl, OH and NR⁶R⁷, R⁶ and R⁷ independently of one another being H, hydroxyalkyl or alkyl, which is uninterrupted or interrupted by one or more oxygen atoms and/or NR⁵ groups, R⁵ being H, hydroxyalkyl, (CH₂)ₙNR⁶R⁷, where n is from 2 to 5 and R⁶ and R⁷ are as defined above, or alkyl, which may in turn be interrupted by one or more NR⁵ groups, R⁵ possessing the abovementioned definitions, and/or substituted by one or more NR⁶R⁷ groups, R⁶ and R⁷ possessing the abovementioned definitions;
or A is a radical of the formula:

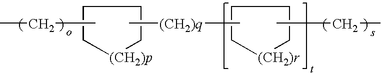

where
o, q and s independently of one another are 0 or an integer from 1 to 6,
p and r independently of one another are 1 or 2, and
t is 0, 1 or 2,
it also being possible for the cycloaliphatic radicals to be substituted by 1, 2 or 3 alkyl radicals, and R¹, R² and R³ and R⁴ independently of one another are H, hydroxyalkyl, alkyl or cycloalkyl.

Preferred β-hydroxyalkylamines of relatively high functionality are, in particular, at least doubly ethoxylated amines having a molar weight of less than 1000 g/mol, such as diethanolamine, triethanolamine and ethoxylated diethylenetriamine, for example, preferably stoichiometrically ethoxylated diethylenetriamine, i.e., diethylenetriamine, in which on average all NH hydrogen atoms are monoethoxylated.

Particularly suitable additional crosslinkers include β-hydroxyalkylamides, preferably the β-hydroxyalkylamides specified in U.S. Pat. No. 5,143,582, of the formula

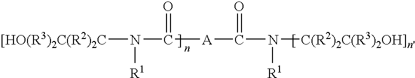

Particularly preferred β-hydroxyalkylamides of the above formula are those in which R¹ is hydrogen, a short-chain alkyl group, or HO(R³)₂C(R²)₂C—, n and n′ are each 1, -A- is a —(CH₂)m- group, m is from 0 to 8, preferably from 2 to 8, R² in each case is hydrogen, and in each case one of the R³ groups is hydrogen and the other is hydrogen or C₁-C₅ alkyl. Bis[N,N-di(2-hydroxyethyl)]adipamide is particularly preferred.

The addition of the crosslinker generally brings about better curing of the compositions of the invention at a given curing temperature, or, respectively, curing at low temperature for a given curing time. The weight fraction of the crosslinker relative to the sum of polymer A1 and A2 is from 0 to 30% by weight, preferably from 0.1 to 15% by weight.

In addition, a reaction accelerant may be added to the polymer dispersions D. Preferred such accelerants are phosphorus compounds, especially hypophosphorous acid and its alkali metal salts and alkaline earth metal salts, or alkali metal tetrafluoroborates. Further reaction accelerants which may be added include salts of Mn(II), Ca(II), Zn(II), Al(III), Sb(III) or Ti(IV), or strong acids, such as para-toluenesulfonic acid, trichloroacetic acid and chlorosulfonic acid. The weight fraction of the reaction accelerant relative to the sum of polymer A1 and A2 is from 0.1 to 5% by weight, preferably from 0.1 to 2% by weight.

Particularly preferred compositions of the polymer dispersions D are as follows:

from 70 to 50% by weight of polymer A1,
from 30 to 50% by weight of polymer A2 and if desired
from 0 to 10% by weight of surface-active alkoxylated alkylamine,
from 0 to 20% by weight of hydroxyl-containing crosslinkers,
from 0 to 5% by weight of reaction accelerants.

The preparation of the aqueous polymer dispersions D takes place as described in EP 1 240 205.

The dispersion is used in amounts of 1 to 80%, preferably 10 to 75% and with particular preference 20 to 50% by weight.

For the preparation of the formaldehyde-free binders of the invention the polymer of A) and B) and component C) are preferably used in a ratio relative to one another such that the molar ratio of carboxyl groups of components A) and B) to the hydroxyl groups of component C) is from 20:1 to 1:1, more preferably from 8:1 to 5:1, and with particular preference from 5:1 to 1.7:1 (counting the anhydride groups here as 2 carboxyl groups).

The formaldehyde-free aqueous binders of the invention are prepared, for example, simply by adding components C) and D), to the aqueous dispersion or solution of the polymers of A) and B). However, the polymer dispersion D) can also be prepared in the presence of the other components.

The binders of the invention comprise preferably less than 1.0% by weight, more preferably less than 0.5% by weight, and very preferably less than 0.3% by weight, in particular less than 0.1% by weight, based on the sum of A), B), C) and D), of a phosphorus-comprising reaction accelerant. Phosphorus-comprising reaction accelerants are referred to in EP 651 088 and EP 583 086, DE 196 21523, and EP 826 710. In particular they are alkali metal hypophosphites, alkali metal phosphites, alkali metal polyphosphates, alkali metal dihydrogenphosphates, polyphosphoric acid, hypophosphoric acid, phosphoric acid, alkylphosphinic acid or oligomers and polymers of these salts and acids.

The binders of the invention preferably comprise no phosphorus-comprising reaction accelerants, or no amounts of a phosphorus-comprising compound that are effective for accelerating reaction. The binders of the invention may comprise an esterification catalyst, such as sulfuric acid or p-toluenesulfonic acid, for example. The binders of the invention can be used as impregnants or coatings. The binders of the invention may be the sole constituent of the impregnants or coatings. The impregnants or coatings may, however, also comprise further additives suitable for the particular use envisaged. Suitable examples include dyes, pigments, biocides, plasticizers, thickeners, adhesion promoters (e.g., alkoxysilanes, such as γ-aminopropyltriethoxysilane, Witco: Silquest A-1100 silane), reducing agents, and transesterification catalysts, or flame retardants (such as aluminum silicates, aluminum hydroxides, borates or phosphates), melamine/formaldehyde resins, dispersions (acrylates, styrene-butadiene dispersions), epoxy resins, polyurethane resins, emulsifiers (ionic, nonionic), hydrophobicizers (silicones) or retention agents.

The binders of the invention dry (at 50° C. in 72 hours) to form a film from 0.3 to 1 mm in thickness and following a subsequent 15-minute cure at 150° C. in air have a gel content of preferably more than 50% by weight, more preferably more than 60% by weight, very preferably more than 70% by weight, and in particular more than 75% by weight.

When cure is at an end the cured films are stored in water at 23° C. for 48 hours. Soluble fractions remain in the water. The film is then dried to constant weight at 50° C. and weighed. The weight corresponds to the gel content; the gel content is calculated in % by weight, based on the weight before the soluble fractions were separated off. Constant weight is reached when the weight decrease over a 3-hour period is less than 0.5%, in particular less than 0.1% by weight.

The binders of the invention are useful as binders for substrates, such as for producing moldings formed from fibers, chips or shavings, mats or boards, preferably for fibrous and particulate substrates. Examples of fiber webs include webs of cellulose, cellulose acetate, esters and ethers of cellulose, cotton, hemp, sisal, jute, flax, coconut fiber or banana fiber, cork, animal fibers, such as wool or hair, and especially webs of synthetic or inorganic fibers, e.g., aramid, carbon, polyacrylonitrile, polyester, mineral, PVC or glass fibers.

When used as binders for fiber webs the binders of the invention may comprise, for example, the following additives: silicates, silicones, boron compounds, lubricants, wetting agents.

Glass fiber webs are preferred. The unbonded fiber webs, particularly those of glass fibers, are bound, i.e., consolidated, by the binder of the invention.

For this purpose the binder of the invention is applied to the unbonded fiber web, by coating, spraying, impregnating and/or saturating, for example, in a fiber/binder (solids) weight ratio of from 40:1 to 1:1, preferably from 25:1 to 2:1.

The binder of the invention is used here preferably in the form of a dilute aqueous preparation containing from 95% to 40% by weight of water.

After the binder of the invention has been applied to the unbonded fiber web it is generally dried at preferably from 100 to 400° C., in particular 130 to 280° C., very preferably 130 to 230° C., for a period of preferably from 10 seconds to 10 minutes, in particular from 10 seconds to 3 minutes.

The bonded fiber web obtained has a high strength in the dry and wet states. After drying, the bonded fiber web shows no yellowing, or virtually none. The binders of the invention allow in particular short drying times and also low drying temperatures.

The bonded fiber webs, especially glass fiber webs, are useful as or in roofing membranes, as backing materials for wallpapers or as inliners or backing material for floor coverings, for example those of PVC. PVC floor coverings manufactured using PVC plastisols and glass fiber webs consolidated with the binders of the invention have little tendency to yellow.

When used as roofing membranes, the bonded fiber webs are generally coated with bitumen.

The binders of the invention can additionally be used as binders for insulating materials composed of the abovementioned fibers, particularly inorganic fibers such as mineral fibers and glass fibers.

The hitherto customary binders of the art, based on phenol-formaldehyde condensation resins, have the disadvantage that significant quantities of phenol, formaldehyde, and low molecular mass condensation products are emitted from them in vapor form during the preparation of the insulating materials. Great expense and effort is involved in restraining these environmentally hazardous substances. In addition, there may also be release of formaldehyde from the finished insulant products, which is undesirable particularly when they are used in residential buildings.

Fibers for insulating materials are produced in industry to a great extent by the spinning of melts of the corresponding raw mineral materials (see for example EP 567 480).

In the manufacture of insulating materials the aqueous binder solution is preferably sprayed onto the freshly prepared fibers while they are still hot. Most of the water evaporates, leaving the resin in an essentially uncured state as a viscous, high-solids material adhering to the fibers. The fibers are then used to produce binder-containing fiber mats, which are transported on through a curing oven by suitable conveyor belts. In the oven, the resin cures at oven temperatures of from about 150 to 350° C. After the curing oven, the insulant mats are finished in a suitable way, i.e., cut into a shape suitable for the end user.

The binders used in practice to produce insulating materials may comprise customary auxiliaries and additives. Examples of such are hydrophobicizers such as silicone oils, alkoxysilanes such as 3-aminopropyltriethoxysilane as coupling agent, soluble or emulsifiable oils as lubricants, and dust-binding agents, and also wetting assistants.

The predominant proportion of the mineral fibers or glass fibers used in the insulating materials have a diameter of between 0.5 and 20 μm and a length of between 0.5 and 10 cm.

Customary use forms of the insulating materials are rectangular or triangular insulant sheets and rolled-up webs. The thickness and density of the insulating materials can be varied within wide limits, allowing the production of products having the desired insulating effect. Customary thicknesses are between 1 and 20 cm, customary densities in the range between 5 and 300 kg/m³. The insulating effect is characterized by the thermal conductivity lambda (in mW/mK). The insulant sheets have a high dry and wet strength.

The binders of the invention are also suitable for manufacturing abrasive cloths, examples being pan cleaners or pan scourers based on bonded fiber webs. Suitable fibers include natural fibers and synthetic fibers (e.g., nylon). In the case of the pan cleaners and scourers the fiber webs are preferably consolidated in a spraying process.

The binders are additionally suitable for producing woodbase materials such as wood chipboard and wood fiberboard (cf. Ullmanns Encyclopädie der technischen Chemie, 4^{th} edition, 1976, Volume 12, pp. 709-727), which can be manufactured by gluing disintegrated wood, such as wood chips and wood fibers, for example.

The water resistance of woodbase materials can be enhanced by adding to the binder a commercially customary aqueous paraffin dispersion or other hydrophobicizer, or adding these hydrophobicizers beforehand or afterward to the fibers, chips or shavings. Chipboard production is common knowledge and is described in, for example, H. J. Deppe, K. Ernst Taschenbuch der Spanplaltentechnik, 2^{nd} edition, Verlag Leinfelden 1982.

It is preferred to use chips whose average thickness is from 0.1 to 2 mm, in particular from 0.2 to 0.5 mm, and which contain less than 6% by weight of water. The binder is applied with great uniformity to the wood chips, the binder:wood chip weight ratio based on solids (calculated as A)+B)) being preferably from 0.02:1 to 0.3:1. Uniform distribution can be achieved by, for example, spraying the binder in finely divided form onto the chips.

The glued wood chips are then scattered out to form a layer with a highly uniform surface, the thickness of the layer being guided by the desired thickness of the finished chipboard. The scattered layer is pressed at a temperature of from 100 to 250° C., for example, preferably from 140 to 225° C., by applying pressures of usually from 10 to 750 bar, to form a dimensionally stable board. The press times required may vary within a wide range and are generally from 15 seconds to 30 minutes.

The wood fibers of appropriate quality required to produce medium-density fiber board (MDF) from the binders can be produced from barkless wood chips by milling in special mills or refiners at temperatures of about 180° C.

For gluing, the wood fibers are generally swirled up in a stream of air and the binder is introduced through nozzles into the resultant fiber stream (blow-line process). The ratio of wood fiber to binder based on the dry-matter content or solids content is usually from 40:1 to 3:1, preferably from 20:1 to 4:1. The glued fibers are dried in the fiber stream at temperatures, for example, of from 130 to 180° C., scattered out to form a fiber web, and pressed under pressures of from 20 to 40 bar to form boards or moldings.

Alternatively, as described for example in DE-A 2 417 243, the glued wood fibers can be processed to a transportable fiber mat. This intermediate can then be processed further to boards or shaped parts, such as door interior trim panels of motor vehicles, for example, in a second, temporally and spatially separate step.

The binders of the invention are additionally useful for producing plywood and carpentry board according to the commonly known manufacturing processes.

Other natural fiber materials as well, such as sisal, jute, hemp, flax, kenaf, coconut fibers, banana fibers and other natural fibers, can be processed with the binders to form boards and moldings. The natural fiber materials can also be used in mixtures with synthetic fibers, such as polypropylene, polyethylene, polyesters, polyamides or polyacrylonitrile. These synthetic fibers may in this case also function as cobinders alongside the binder of the invention. The fraction of the synthetic fibers is preferably less than 50% by weight, in particular less than 30% by weight, and very preferably less than 10% by weight, based on all shavings, chips or fibers. The fibers can be processed by the method employed for wood fiber board. Alternatively, preformed natural fiber mats can be impregnated with the binders of the invention, with the optional addition of a wetting assistant. The impregnated mats are then pressed, in the binder-moist or pre-dried state, at temperatures between 100 and 250° C. and pressures between 10 and 100 bar, for example, to form boards or shaped parts.

The moldings obtained in accordance with the invention feature low water absorption, little increase in thickness (swelling) after water storage, high strength, and absence of formaldehyde. They can be used in the automobile industry, for instance.

A further application of the binders of the invention is their use in the manufacture of abrasive materials, especially abrasive paper, abrasive cloth (woven or nonwoven) or other abrasive articles. In this context it can be advisable to adjust the aqueous polymer dispersions, prior to application to the paper or cloth in question or the corresponding article, to a pH of from 3 to 8, in particular from 3 to 5, by adding various organic or inorganic bases. Suitable bases include ammonia, organic monofunctional or polyfunctional amines, alkoxides, and metal alkyl compounds, but also inorganic bases such as sodium hydroxide or sodium carbonate, for example.

The likewise inventive abrasive materials obtainable in this way contain customary abrasive grit, based for example on corundum, quartz, garnet, pumice, tripel, silicon carbide, emery, aluminas, zironias, kieselguhr, sand, gypsum, boron carbide, borides, carbides, nitrides, cerium oxide or silicates.

Ways of producing the abrasive materials of the invention include the application first to the paper, cloth or article in question of the aqueous polymer solution, modified where appropriate with—for example—dispersions, followed by the addition of the abrasive grit selected and, finally, by the addition of further quantities of the aqueous polymer solution, again modified where appropriate with dispersions, for example, which is referred to as a size coat.

The inventive use of the aqueous polymer solution results in improved abrasive materials, featuring qualities including high flexibility, toughness/elasticity, tensile strength, and breaking extension, which have favorable abrasion behavior, and in which the abrasive grit is thoroughly bound.

A further inventive use of the binders is for producing filter materials, particularly filter papers or filter cloths. Examples of possible cloth materials include cellulose, cotton, polyesters, polyamide, PE, PP, glass webs, and glass wool. It can be advisable to adjust the aqueous polymer solutions to a pH of from 2 to 8, in particular from 3.0 to 6.5, before applying them to the corresponding paper or cloth, by addition of various organic or inorganic bases. Suitable bases include triethanolamine, diethanolamine, monoethanolamine, hydroxyalkylamines, ammonia, organic monofunctional or polyfunctional amines, alkoxides, and also metal alkyl compounds, and also inorganic bases such as sodium hydroxide or potassium hydroxide, for example. The adjustment of the pH to the stated range of values has the effect, among others, of reducing the drop in bursting strength following storage or thermal exposure and hence of achieving a high thermal stability.

Application of the polymer solution for inventive use to the filter materials, i.e., to filter paper or filter cloth, inter alia, is accomplished preferably by the impregnating method or by spraying. In these cases the aqueous polymer solutions are applied to the filter materials by resination. After the filter materials have been resinated with the aqueous polymer solutions they are heated, advisably, for from 0.1 to 60 minutes, in particular from 1 to 60 minutes, at temperatures from 100 to 250° C., in particular from 110 to 220° C., to cure them.

The inventive use of the aqueous polymer solution as a binder for filter materials means that the treated filter materials have, among other qualities, an enhanced mechanical stability (higher tensile strength and bursting strength), especially after storage under damp conditions and at elevated temperature. The inventive use of the aqueous binders also has the effect that the resultant filter materials are characterized by qualities including high chemical resistance, to solvents for example, without any effect on the permeability (pore size) of the filter material. Through the use of the aqueous polymer solutions it is also observed that they give the filter materials a high strength even after drying (dry tensile strength), and yet after drying below the curing temperature of the aqueous polymer solutions the filter materials can still be readily subjected to deformation by folding, grooving or pleating. Following subsequent thermal curing (heat treatment) the polymer solutions give the resultant and likewise inventive filter materials, primarily filter papers or filter cloths, a high dimensional stability. This quality makes it possible to produce intermediates and so to breakdown the manufacturing operation into individual, independent production steps.

A further inventive use of the aqueous polymer solutions is as binders for cork, cork webs, cork mats or cork board.

The examples below are intended to illustrate the invention, though without restricting it to them:

### EXAMPLES

Preparation procedures, general, for components A and/or B:

### a) In Situ:

The polymers having a broad molecular weight distribution can be prepared in situ in one step by first synthesizing the low molecular mass fraction (at defined initiator concentration/temperature) and, after adding 0-100% of the monomers, lowering the initiator concentration in the reaction mixture and/or reducing the temperature (gradually or continuously); or the multimodal polymers can be prepared in situ in one step by first synthesizing the high molecular mass fraction (at defined initiator concentration/temperature) and, after adding 100-0% of the monomers, raising the initiator concentration in the reaction mixture and/or increasing the temperature.

### b) Mixing:

The polymers having a broad molecular weight distribution can be prepared by mixing polymers having different molecular weights.

### c) Polymerizing One Component in the Presence of the Other

The polymers having a broad molecular weight distribution can be prepared by synthesizing one polymer of low or high molecular weight in the presence of a second polymer with high or low molecular weight respectively.

Preparation instructions generally for binders:
a) mixing: A and B with C and/or D
b) in situ polymerization:
   1. C and/or D present during the synthesis of A and B, mix in remainder if appropriate
   2. 2. A and/or B and/or C during the synthesis of D, mix in remainder if appropriate

### Methods of Analysis and Testing

### Gel Permeation Chromatography

A combination of 4 separating columns (each of internal diameter 7.8 mm and length 30 cm, column temperature 35° C. in each case) with the following separation materials was used:

| Column No. | Separation material | Polyethylene oxide cut off |
|---|---|---|
| 1 | TSK G5000 PW xl | 4 000-1 000 000 |
| 2 | Waters Ultrahydrogel 1 000 | 1 000 000 |
| 3 | Waters Ultrahydrogel 500 | 400 000 |
| 4 | Waters Ultrahydrogel 500 | 400 000 |

The eluent used was 0.008 M TRIS buffer (tris(hydroxymethyl)aminomethane, Merck, Darmstadt) at a pH of 7 in distilled water, with the addition of 0.15 mol/L NaCl and 0.01 mol/L NaN₃.

400 μL of each sample solution were injected.

The flow rate was 0.5 mL/min. At this flow rate, the theoretical plate number for the separating column combination was 37 000.

The detector used was an ERC 7510 differential refractometer from ERMA.

Evaluation was ended after a volume of 39.6 mL (M(Na PAA) about 642) had passed through (integration limit). The chromatograms obtained were integrated in accordance with DIN 55672-1 with an accuracy of ±3%.

### Performance Tests:

### Binder Formulation:

The binder solution is admixed with about 1% by weight of γ-aminopropyltriethoxysilane with respect to the sum of all of the components.

### Base web:

Glass web, approximately 50 g/m²

### Consolidation:

The base webs, 32 cm long and 28 cm wide, are guided lengthwise over a continuous PES screen belt first through a 20% binder liquor and subsequently via a suction apparatus. The belt speed is 0.6 m/min. The wet add-on is controlled by the adjustable strength of the suction. In the case of a wet add-on of approximately 100% the dry add-on, with a binder liquor concentration of 20%, is 20%+−2%.

The impregnated webs are cured at 200° C. for 2 minutes on a PES net support in a Mathis dryer (hot air is set at maximum).

### Preparation of the Test Specimens:

Test specimens for testing the tensile strength and for testing the loss on boiling in the longitudinal direction are cut from the web. The size of the webs is as follows:
for the tensile strength at 23° C. without further treatment (“tensile strength, RT”) 240×50 mm
for the tensile strength after storage for 15 minutes in hot water at 80° C. (“tensile strength, wet”) 240×50 mm
for the tensile strength after storage for 1 minute in a drying oven at 180° C. (“tensile strength, hot”) 240×50 mm.

### Tests:

a) Tensile strengths: the averaged test results are reported in N/5 cm; the clamped length for the “dry”, “wet” and “hot” tensile strength tests is 200 mm. The takeoff speed is set at 25 mm/min. The tensile strengths are corrected for weight to 60 g/m² (calculation formula: Fₘₐₓ*60 μg/mg/“actual weight” [g/m²]).
b) Determination of loss on boiling
   Two test sections measuring 10×10 cm are cut from the web specimen and dried at 130° C. for 10 minutes, weighed, placed in boiling condensed water for 15 minutes and then dried at 130° C. for 1 h, cooled in a desiccator and weighed.
   The weight loss is reported in % based on bonded web.

### EXAMPLES

### Comparative Example 1

Acrylic acid:maleic acid 62.5:37.5% by weight copolymer, 40% triethanolamine, M_{w}: 77 000 g/mol, polydispersity: 11.7

### Example 1

Comparative example 1+dispersion 1=50:50% by weight

### Example 2

Comparative example 1+dispersion 1=67:33% by weight

### Dispersion 1:

47.8% by weight, protective colloid
Acrylic acid/maleic acid 70:30% by weight copolymer, M_{w}: 10 000 g/mol, esterified with 18% by weight of ethoxylated oleylamine (10 EO) with respect to acrylic acid/maleic acid
47.8% by weight, latex
70% by weight styrene, 25% by weight methyl methacrylate, 5% by weight hydroxyethyl acrylate
4.4% by weight triethanolamine
as a 50% dispersion in water

TABLE 1

| | Curing 2′, 180° C. | | | | | | | |
|---|---|---|---|---|---|---|---|---|
| | | | | Loss on | | | | |
| | | | | boiling | Curing 2′, 200° C. | | | |
| | TS, dry | TS, wet | TS, hot | [%] based | TS, dry | TS, wet | TS, hot | Loss on |
| Example | [N/5 cm] | [N/5 cm] | [N/5 cm] | on binder | [N/5 cm] | [N/5 cm] | [N/5 cm] | boiling |
| Comparative | 159 | 89 | 150 | 12 | 158 | 114 | 142 | 6 |
| example 1 | | | | | | | | |
| Example 1 | 170 | 124 | 156 | 6 | 165 | 139 | 145 | 2 |
| Example 2 | 167 | 116 | 156 | 8 | 165 | 152 | 146 | 3 |
| | Curing 2′, 140° C. | | | | | | | |
| | | | | Loss on | | | | |
| | | | | boiling | Curing 2′, 160° C. | | | |
| | TS, dry | TS, wet | TS, hot | [%] based | TS, dry | TS, wet | TS, hot | Loss on |
| Example | [N/5 cm] | [N/5 cm] | [N/5 cm] | on binder | [N/5 cm] | [N/5 cm] | [N/5 cm] | boiling |
| Comparative | 157 | 67 | 139 | 38 | 146 | 64 | 135 | 23 |
| example 1 | | | | | | | | |
| Example 1 | n.d. | n.d. | n.d. | n.d. | 166 | 95 | 136 | 13 |
| Example 2 | 162 | 70 | 151 | 30 | 176 | 90 | 152 | 13 |

TS: tensile strength

1. Formaldehyde-free aqueous binders for substrates, having a broad molecular weight distribution, comprising
(A) from 0 to 100% by weight of a polymer derived from an ethylenically unsaturated acid anhydride or ethylenically unsaturated dicarboxylic acid whose carboxylic acid groups can form an anhydride group, or mixtures thereof,
(B) from 100 to 0% by weight of a polymer derived from an ethylenically unsaturated compound,
(C) at least one polyfunctional crosslinker or mixtures thereof, and
(D) from 1 to 80% by weight of an aqueous polymer dispersion,
wherein polymers A) and B) are obtained by free-radical addition polymerization and, when classified in a coordinate system by way of their average molecular weight Mw and their polydispersity, are situated in the area above a straight line which is defined by the linear equation y=1.25x+20 000 which has been shifted in the y direction parallelwise by at least +3 000, the x axis denoting the weight-average molecular weight and the y axis the polydispersity times 10 000.

2. The formaldehyde-free aqueous binders as claimed in claim 1, wherein polymers A) and B) have a broad molecular weight distribution.

3. The formaldehyde-free aqueous binders as claimed in claim 1, wherein the aqueous binders include less than 1.5% by weight, based on the sum of A), B), C) and D), of a phosphorus-containing reaction accelerant.

4. The formaldehyde-free aqueous binders as claimed in claim 1, wherein polymers A) and B) comprise from 5 to 100% by weight of maleic acid.

5. The formaldehyde-free aqueous binders as claimed in claim 4, wherein polymers A) and B) comprise acrylic acid and maleic acid.

6. The formaldehyde-free aqueous binders as claimed in claim 1, wherein C) is an alkanolamine compound of formula I 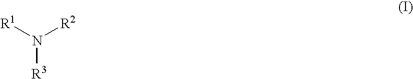
where R¹ is hydrogen, C₁-C₁₀ alkyl or C₁-C₁₀ hydroxyalkyl and R² and R³ are each C₁-C₁₀ hydroxyalkyl.

7. The formaldehyde-free aqueous binders as claimed in claim 1, wherein C) is triethanolamine.

8. The formaldehyde-free aqueous binders as claimed in claim 1, wherein aqueous dispersion D) is selected from the group consisting of straight acrylates, styrene-acrylates, X-styrene-butadienes (XSB), and polyurethanes or a modified dispersion comprising polycarboxylic acid with alcohol as crosslinker.

9. The formaldehyde-free aqueous binders as claimed in claim 1, wherein the aqueous dispersion D) comprises
from 70 to 50% by weight of polymer A1
from 30 to 50% by weight of polymer A2 and optionally
from 0 to 10% by weight of surface-active alkoxylated alkylamine,
from 0 to 20% by weight of hydroxyl-containing crosslinkers, and
from 0 to 5% by weight of reaction accelerants.

10. The formaldehyde-free aqueous binders as claimed in claim 1, wherein dispersion D) is mixed into components A), B), and C).

11. The formaldehyde-free aqueous binders as claimed in claim 1, wherein dispersion D) is prepared in the presence of components A), B), and C).

12. Binders for fibers, fiber mats and fiber webs comprising the formaldehyde-free aqueous binders as claimed in claim 1.

13. Binders for glass fibers, glass fiber webs, glass fiber mats, mineral fibers, mineral fiber webs and mineral fiber mats comprising the formaldehyde-free aqueous binders as claimed in claim 1.

14. A process for producing bonded fiber webs, which comprises coating, spraying or impregnating fiber webs with an aqueous binder as set forth in claim 1 and subsequently drying and thermally curing them.

15. The process as claimed in claim 14 for producing bonded glass fiber webs or mats.

16. Bonded fiber webs or mats obtainable by using a formaldehyde-free aqueous binder as set forth in claim 1.

17. Bonded glass fiber webs or mats obtainable by using a formaldehyde-free aqueous binder as set forth in claim 1.

18. Roofing membranes comprising bonded fiber webs or mats as claimed in claim 16.

19. Roofing membranes comprising bonded glass fiber webs or mats as claimed in claim 17.

20. Insulating materials comprising bonded fiber webs or mats as claimed in claim 16.

21. Floor coverings comprising bonded fiber webs or mats as claimed in claim 16.

22. Insulating materials comprising bonded glass fiber webs or mats as claimed in claim 17.

23. Floor coverings comprising bonded glass fiber webs or mats as claimed in claim 17.

24. Moldings comprising fibers, chips or shavings and the formaldehyde-free aqueous binders as claimed in claim 1.

25. The moldings as claimed in claim 24, wherein the fibers, chips or shavings are composed of renewable raw materials.

26. The moldings as claimed in claim 24, wherein the fibers are natural or synthetic fibers or mixtures thereof.

27. The moldings as claimed in claim 24, wherein the fibers, chips or shavings are in the form of substrates of wood fibers, wood chips, jute, sisal, flax, hemp or kenaf.

28. The moldings as claimed in claim 24, wherein the fibers, chips or shavings are in the form of substrates of wood chipboard panels.

29. A method of using the formaldehyde-free aqueous binders as claimed in claim 1 as binders for filter materials.

30. A method of using the formaldehyde-free aqueous binders as claimed in claim 1 as binders for abrasives.

31. A method of using the formaldehyde-free aqueous binders as claimed in claim 1 as binders for cork.

32. (canceled)
